(19) United States
(12) Patent Application Publication
(10) Pub. No.: US 2007/0192963 A1
(43) Pub. Date: Aug. 23, 2007

(54) Method for improving the appearance of vinyl or leather objects

(76) Inventor: Kermit H. Cramer, Henderson, NV (US)

Correspondence Address: WEISS & MOY PC, 4204 NORTH BROWN AVENUE, SCOTTSDALE, AZ, 85251, US

(21) Appl. No.: 11/357,268

(22) Filed: Feb. 17, 2006

(51) Int. Cl. C11D 3/00

(52) U.S. Cl. 8/115.51

(57) ABSTRACT

A method for improving the appearance of marked vinyl or leather objects involves the initial step of identifying an undesired marking on the vinyl or leather object, then cleaning the object with a cleaner, then covering the marking with a dye, and completing by applying a protective coating over the dye.

### FIELD OF THE INVENTION

This invention relates generally to methods for improving the appearance of vinyl or leather objects and, more particular, to a method for removing and/or concealing ink and other markings on vinyl or leather objects by initially cleaning the vinyl or leather with chemicals, then covering the marking on the vinyl or leather objects with a vinyl paint and then applying a protective coating on the vinyl or leather objects.

### BACKGROUND OF THE INVENTION

The present invention concerns vinyl and leather objects, especially vinyl and leather railings, as well as other vinyl and leather objects, such as furniture, including, for example, chairs, couches, ottomans, kitchen stools, barstools, and the like. Vinyl and leather objects are becoming increasingly popular and are in use in various types of settings, both commercial and residential. In one example, vinyl railings and leather railings are utilized in casinos to, for example, line certain kinds of gaming tables. In these settings, the railings are regularly contacted by individuals, and, as a consequence, they may become spilled on, stained, marked up and/or scuffed.

Generally, vinyl objects, and sometimes leather objects, are often promoted as being relatively maintenance free. Accordingly, in the past, cleaning vinyl or leather objects and removing certain forms of dust and/or dirt from them has often involved the use of such things as mild cleansers and/or soap and water. However, such methods and other current methods for cleaning vinyl or leather objects do not always successfully remove spills, tough stains, markings, scuffs, and the like from vinyl or leather objects. As a consequence, it may become necessary to simply replace the objects. Especially with respect to vinyl or leather railings, doing so can be labor intensive, time consuming, and/or expensive. Replacing vinyl or leather objects may also seem wasteful, particularly when only a portion thereof is stained, marked up and/or scuffed.

A need therefore exists for improving the appearance of vinyl or leather objects without having to replace them.

The present invention satisfies these needs and provides other, related advantages.

### SUMMARY OF THE INVENTION

In accordance with an embodiment of the present invention, a method for improving the appearance of vinyl or leather objects is disclosed. The method comprises: identifying an undesired marking on the object; cleaning the object with a cleaner; covering an area of the object having the marking thereon with a dye, wherein a color of the dye matches a color of the object; waiting a period of time to allow the dye to dry; and applying a protective coating over the dye.

In accordance with another embodiment of the present invention, a method for improving the appearance of vinyl or leather objects is disclosed. The method comprises: identifying an undesired marking on the object; cleaning the object with a cleaner; covering an area of the object having the marking thereon with one of a primer and adhesion promoter; waiting a period of time to allow one of the primer and adhesion promoter to dry, covering an area of the object having the marking thereon with a dye, wherein a color of the dye matches a color of the object; waiting another period of time to allow the dye to dry; and applying a protective coating over the vinyl dye.

In accordance with a further embodiment of the present invention, a method for improving the appearance of vinyl or leather objects is disclosed. The method comprises: identifying an undesired marking on the object; cleaning the object with a cleaner; covering an area of the object having the marking thereon with one of a primer and adhesion promoter; waiting a period of time to allow one of the primer and adhesion promoter to dry; covering an area of the object having the marking thereon with a dye, wherein a color of the dye matches a color of the object; waiting another period of time to allow the dye to dry; and applying a protective coating over the entire object.

### BRIEF DESCRIPTION OF THE DRAWINGS

FIG. 1 is a flow chart showing the steps involved in an embodiment of the present invention.

FIG. 2 is a flow chart showing the steps involved in an embodiment of the present invention.

FIG. 3 is a flow chart showing the steps involved in an embodiment of the present invention.

### DETAILED DESCRIPTION OF THE PREFERRED EMBODIMENTS

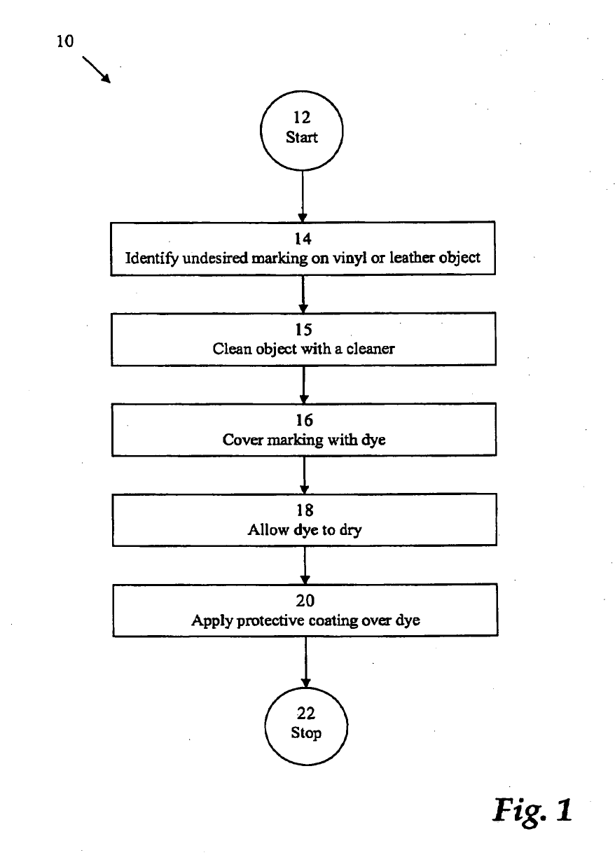

Referring first to FIG. 1, a flowchart shows the steps of a method for improving the appearance of vinyl or leather objects (hereafter the “method 10”), consistent with an embodiment of the present invention. The method 10 is useful for the removal and/or concealment of undesired markings that may be found on vinyl or leather objects. Such markings may involve any kind of surface disfigurement of the objects, such as beverage spills, stains, scuff marks, etc. The present invention first employs chemicals to clean the vinyl or leather containing the undesired markings, and then employs a dye to cover the area containing the undesired markings. Such dye may be epoxy based, may be composed of urethane and acrylic resin, or may have some other desired composition suitable for vinyl or leather surfaces. When cosmetically repairing a vinyl or leather object containing an undesired marking, applying a dye to the undesired marking will completely conceal the marking, resulting in an improved appearance of the vinyl or leather object without a need for replacement. The method 10 may be particularly appropriate for use in any places where vinyl or leather objects, especially railings, are commonly found, including for example in casinos, where they are utilized with certain gaming apparatuses, such as craps tables.

A preferred embodiment of the method 10 comprises the following steps: identifying an undesired marking on a vinyl or leather object 14. This step ensures that any and all undesired markings on the vinyl or leather object in question will be located, and therefore, that the overall appearance of the vinyl or leather object will be improved. The next step is to clean the vinyl or leather object with chemicals 15. In one embodiment, an ink remover and a vinyl cleaner may be used to accomplish this step. However, other desired chemicals suitable for cleaning vinyl or leather may be used. The chemicals remove any contaminants, such as beverage spills, oil from the skin, and/or ink that has not penetrated the vinyl or leather. The next step is to cover the undesired marking with a dye 16. Preferably, the color of the dye will match the color of the vinyl or leather object. In this way, the marking may be covered with the dye without altering the color scheme and overall appearance of the vinyl or leather object. Preferably, the dye is sprayed on and molecularly binds to the vinyl or leather. In one embodiment, the dye is applied using an aerosol dispenser. The dispenser may be fastened on a container holding the dye. Spraying on the dye helps to ensure that an even coat of dye is applied. The next step is to wait a period of time to allow the dye to dry 18. This step ensures a dry surface on which to perform the final step. The final step is to apply a protective coating over the dye 20. This step will help protect the previously marked area of the vinyl or leather object from further marking and/or contaminants, will help maintain the flexibility of the vinyl or leather, and will help to prevent drying and cracking of the vinyl or leather by replacing oils that naturally occur in the vinyl or leather. The protective coating may be a vinyl or leather conditioner, or some other desired protective coating. Depending upon whether a heavy, light, or moderate coat is applied, it may take up to approximately twenty minutes for the protective coating to dry.

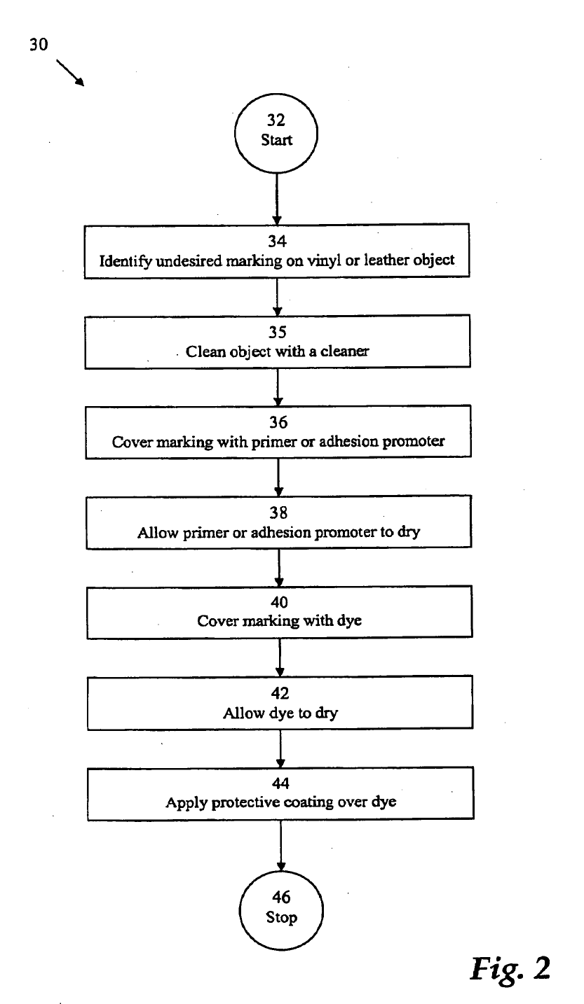

Referring next to FIG. 2, a flowchart shows the steps of a method for improving the appearance of vinyl or leather objects (hereafter the “method 30”), consistent with an embodiment of the present invention. As with the method 10, the method 30 is useful for the removal and/or concealment of undesired markings that may be found on vinyl or leather objects, as described above. The method 30 may also be appropriate for use in any places where vinyl or leather objects may be found, such as in casinos.

A preferred embodiment of the method 30 comprises the following steps: identifying an undesired marking on a vinyl or leather object 34. This step ensures that any and all undesired markings on the vinyl or leather object in question will be located, and therefore, that the overall appearance of the vinyl or leather object will be improved. The next step is to clean the vinyl or leather object with chemicals 35. In one embodiment, an ink remover and a vinyl cleaner may be used to accomplish this step. However, other desired chemicals suitable for cleaning vinyl or leather may be used. The chemicals remove any contaminants, such as beverage spills, oil from the skin, and/or ink that has not penetrated the vinyl or leather. The next step is to cover the undesired marking with a primer or adhesion promoter 36. This step may be desired in order to prepare the area containing the undesired marking for later application of a dye. In this way, the dye may better adhere to the surface containing the undesired marking. The next step is to wait a period of time to allow the primer or adhesion promoter to dry 38. This step ensures a dry surface on which to perform the next step. The next step is to cover the undesired marking with a dye 40. Preferably, the color of the dye will match the color of the vinyl or leather object In this way, the marking may be covered with the dye without altering the color scheme and overall appearance of the vinyl or leather object Preferably, the dye is sprayed on and molecularly binds to the vinyl or leather. In one embodiment, the dye is applied using an aerosol dispenser. The dispenser may be fastened on a container holding the dye. Spraying on the dye helps to ensure that an even coat of dye is applied. The next step is to wait a period of time to allow the dye to dry 42. This step ensures a dry surface on which to perform the final step. The final step is to apply a protective coating over the dye 44. This step will help protect the previously marked area of the vinyl or leather object from further marking and/or contaminants, will help maintain the flexibility of the vinyl or leather, and will help to prevent drying and cracking of the vinyl or leather by replacing oils that naturally occur in the vinyl or leather. The protective coating may be a vinyl or leather conditioner, or some other desired protective coating. Depending upon whether a heavy, light, or moderate coat is applied, it may take up to approximately twenty minutes for the protective coating to dry.

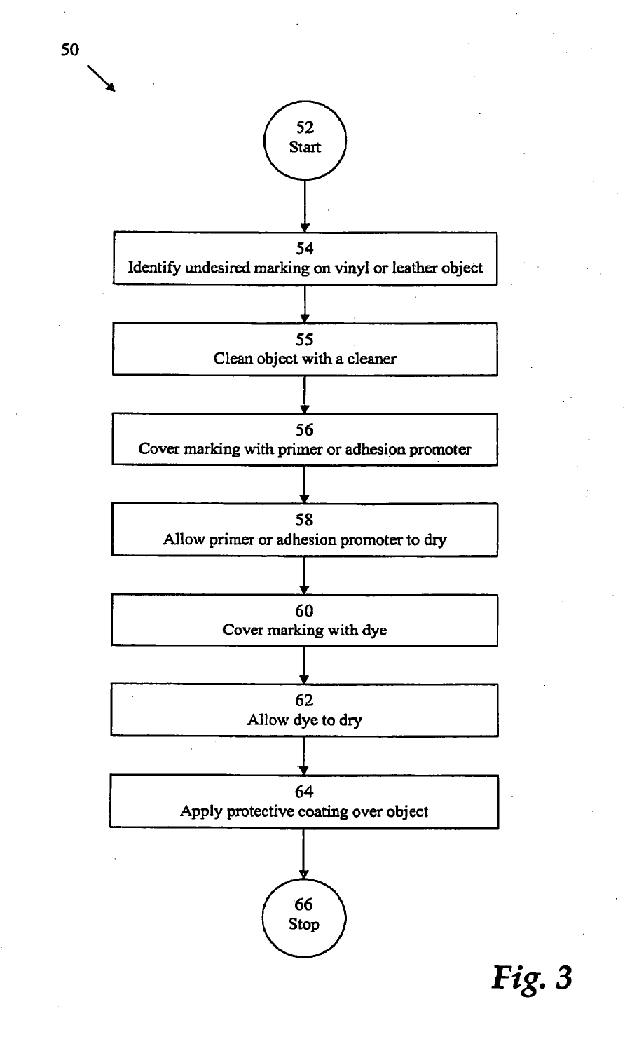

Referring now to FIG. 3, a flowchart shows the steps of a method for improving the appearance of vinyl or leather objects (hereafter the “method 50”), consistent with an embodiment of the present invention. As with the methods 10 and 30, the method 50 is useful for the removal and/or concealment of undesired markings that may be found on vinyl or leather objects, as described above. The method 50 may also be appropriate for use in any places where vinyl or leather objects may be found, such as in casinos.

A preferred embodiment of the method 50 comprises the following steps: identifying an undesired marking on a vinyl or leather object 54. This step ensures that any and all undesired markings on the vinyl or leather object in question will be located, and therefore, that the overall appearance of the vinyl or leather object will be improved. The next step is to clean the vinyl or leather object with chemicals 55. In one embodiment, an ink remover and a vinyl cleaner may be used to accomplish this step. However, other desired chemicals suitable for cleaning vinyl or leather may be used. The chemicals remove any contaminants, such as beverage spills, oil from the skin, and/or ink that has not penetrated the vinyl or leather. The next step is to cover the undesired marking with a primer or adhesion promoter 56. This step maybe desired in order to prepare the area containing the undesired marking for later application of a dye. In this way, the dye may better adhere to the surface containing the undesired marking. The next step is to wait a period of time to allow the primer or adhesion promoter to dry 58. This step ensures a dry surface on which to perform the next step. The next step is to cover the undesired marking with a dye 60. Preferably, the color of the dye will match the color of the vinyl or leather object. In this way, the marking may be covered with the dye without altering the color scheme and overall appearance of the vinyl or leather object Preferably, the dye is sprayed on and molecularly binds to the vinyl or leather. In one embodiment, the dye is applied using an aerosol dispenser. The dispenser may be fastened on a container holding the dye. Spraying on the dye helps to ensure that an even coat of dye is applied. The next step is to wait a period of time to allow the dye to dry 62. This step ensures a dry surface on which to perform the final step. The final step is to apply a protective coating over the entire vinyl or leather object 64. In addition to helping to protect the previously marked area of the vinyl or leather object from further marking, this step will help protect the overall vinyl or leather object from future marking and/or contaminants, will help maintain the flexibility of the vinyl or leather, and will help to prevent drying and cracking of the vinyl or leather by replacing oils that naturally occur in the vinyl or leather. The protective coating may be a vinyl or leather conditioner, or some other desired protective coating. Depending upon whether a heavy, light, or moderate coat is applied, it may take up to approximately twenty minutes for the protective coating to dry.

While the invention has been particularly shown and described with reference to the preferred embodiments thereof, it will be understood by those skilled in the art that the foregoing and other changes in form and details may be made therein without departing from the spirit and scope of the invention.

1. A method for improving the appearance of one of a marked vinyl object and leather object comprising the steps of:
identifying an undesired marking on the object;
cleaning the object with a cleaner;
covering an area of the object having the marking thereon with a dye, wherein a color of the dye matches a color of the object;
waiting a period of time to allow the dye to dry; and
applying a protective coating over the dye.

2. The method of claim 1 wherein the cleaner comprises an ink remover and a vinyl cleaner.

3. The method of claim 1 wherein the dye is epoxy based.

4. The method of claim 1 wherein the dye is a blend of urethane and acrylic resin.

5. The method of claim 1 wherein the dye is applied using an aerosol dispenser.

6. A method for improving the appearance of one of a marked vinyl object and leather object comprising the steps of:
identifying an undesired marking on the object;
cleaning the object with a cleaner;
covering an area of the object having the marking thereon with one of a primer and adhesion promoter;
waiting a period of time to allow one of the primer and adhesion promoter to dry;
covering an area of the object having the marking thereon with a dye, wherein a color of the dye matches a color of the object;
waiting another period of time to allow the dye to dry; and
applying a protective coating over the dye.

7. The method of claim 6 wherein the cleaner comprises an ink remover and a vinyl cleaner.

8. The method of claim 6 wherein the dye is epoxy based.

9. The method of claim 6 wherein the dye is a blend of urethane and acrylic resin.

10. The method of claim 6 wherein the dye is applied using an aerosol dispenser.

11. A method for improving the appearance of one of a marked vinyl object and leather object comprising the steps of:
identifying an undesired marking on the object;
cleaning the object with a cleaner;
covering an area of the object having the marking thereon with one of a primer and adhesion promoter;
waiting a period of time to allow one of the primer and adhesion promoter to dry;
covering an area of the object having the marking thereon with a dye, wherein a color of the dye matches a color of the object;
waiting another period of time to allow the dye to dry; and
applying a protective coating over the entire object.

12. The method of claim 11 wherein the cleaner comprises an ink remover and a vinyl cleaner.

13. The method of claim 11 wherein the dye is epoxy based.

14. The method of claim 11 wherein the dye is a blend of urethane and acrylic resin.

15. The method of claim 11 wherein the dye is applied using an aerosol dispenser.

16. The method of claim 1 wherein the object is a railing.

17. The method of claim 6 wherein the object is a railing.

18. The method of claim 11 wherein the object is a railing.
